(19) United States
(12) Patent Application Publication
(10) Pub. No.: US 2004/0081540 A1
(43) Pub. Date: Apr. 29, 2004

(54) Loading system, and loading car for a loading system

(76) Inventors: Eckhard Uebach, Freudenberg-Heisberg (DE); Walter Kramer, Meckenheim (DE); Ernst-Roland Hopf, Trostberg (DE)

Correspondence Address: JONES, TULLAR & COOPER, P.C., P.O. Box 2266 Eads Station, Arlington, VA, 22202, US

(21) Appl. No.: 10/464,854

(22) Filed: Jun. 19, 2003

(30) Foreign Application Priority Data
Jun. 19, 2002 (DE) 102 27 263.8

(51) Int. Cl. B65G 67/00

(52) U.S. Cl. 414/395

(57) ABSTRACT

The present invention relates to a loading car (1), in particular for transferring a load (2) from a readiness zone (3) to a target zone (4), and to a loading system (20).

The loading car (1) is movable back and forth in a travel direction (5a) and has at least one loading means (6) that is extensible and retractable in a loading direction (5b) that is transverse to the travel direction (5a), and the loading means (6) has a raisable and lowerable load-bearing face (7a) with which the loading means (6) is movable beneath support faces (2a) of the load (2).

The present invention relates to a loading car, in particular for transferring a load from a readiness zone to a target zone, in which the loading car is movable back and forth in a travel direction and has at least one loading means, which is extensible and retractable in a loading direction located transversely to the travel direction, and in which the loading means has a raisable and lowerable load-bearing face with which the loading means is movable beneath support faces.

The present invention further relates to a loading system for transferring a load from a readiness zone to a target zone.

Conventional loading systems, for instance for loading goods into railroad cars, requires that the railroad cars be loaded with forklifts or other loading cars controlled by human operators, which is very time-consuming. Moreover, in the loading, mechanical stresses are caused by vibration and the like and, particularly with complex molded items and similar loads, can lead to damage.

In a further, already-proposed loading system, the positioning accuracy, particularly at high load weights, is inadequate, so that system-dictated tolerances, such as a difference in height between the floor of a car and a loading ramp, cannot always be correctly compensated for.

It is accordingly the object of the present invention to furnish an improved loading system and an improved loading car for a loading system, to enable more-flexible, gentler handling of the load and at the same time shortening loading times.

In a loading car of the type defined at the outset, this object is attained in that the loading means has a carriage supported on rollers.

The loading means, with the load-bearing face lowered entirely or at least partly, is moved on its rollers directly beneath the load to be lifted; for this purpose, the load has suitable recesses for the loading means, and the load-bearing face is braced via the carriage on the rollers and thus on the ground.

Once the loading means is positioned below the load to be lifted, the load-bearing face is raised and thereby lifts the load up by way of its support faces.

The term “support faces of the load” is intended to be understood also to mean support faces that are provided not on some object to be loaded (such as a motor vehicle) itself, but also support faces that are provided on a loading container, such as a container or some other loading aid (such as a pallet).

Because the loading means is braced on the ground in the region below the support faces of the load, in contrast to a forklift, the loading car is prevented from having to absorb a torque engendered by the load. In comparison to the forks of a forklift, the loading means can therefore be embodied as relatively long, without the loading car becoming unstable.

A further highly advantageous embodiment of the loading car of the invention is characterized in that between a top side of the carriage and a U-shaped profile, open at the bottom, that with its bottom side forms the load-bearing face, a hose that can be subjected to compressed air is provided for adjusting the height of the load-bearing face.

Inflation with compressed air brings about a change in volume of the hose, which is braced by its underside on the carriage of the loading means, and whose top is located below the U-shaped profile. Depending on the geometry of the hose and of the regions surrounding it in the loading means, a change in height of up to 60 mm between the lowered and the fully raised state of the load-bearing face can be attained by the inflation of the hose.

Using the hose that can be subjected to compressed air, given a strong filling flow of compressed air, enables a fast and at the same time—in contrast to a conventional undamped, positive connection between the lifting mechanism and the load—low-vibration lifting of the load-bearing face and of the load resting on it, since the inflated hose acts to damp vibration.

In a further advantageous embodiment of the invention, the stability of the lifting mechanism contained in the loading means is increased still further because between the hose and the U-shaped profile, an intermediate plate guided in side walls of the carriage is provided, on which the legs of the U-shaped profile preferably rest.

Still another increase in stability is attainable by adhesively bonding the hose at least in part to the top of the carriage carrying it.

In another highly advantageous embodiment of the invention, preferably in the carriage, a compressed-air connection and/or a venting system for supplying the hose with compressed air and for venting it is provided. This is especially expedient, since then the connection of the compressed air supply or of the venting system can be done very simply on the underside of the hose, which in contrast to the top of the hose does not move relative to the regions, surrounding the hose, of the loading means, such as the side walls or the intermediate plate or the U-shaped profile.

To further shorten the loading time upon lowering the load-bearing face and the load, it, is possible, instead of having the compressed air escape from the loading means simply via a valve under the influence of the force of gravity of the load, to design the venting system in such a way that it generates a negative pressure for venting the hose and applies it to the hose. In this way, venting the hose and thus lowering the load-bearing face and the load can be done even more quickly than would be possible solely by the influence of the force of gravity of the load.

Furthermore, with such a venting system, for various types of load with a highly variable weight, the duration of the lowering operation can be kept constant to make process sequences more predictable. For a lightweight load, for instance, active evacuation of the hose for lowering can be selected; conversely, with a heavy load, the weight of the load itself is enough to assure that the maximum duration sought for the loading operation will not be exceeded.

In another embodiment of the invention, it is provided that the loading means has electromechanical and/or pneumatic and/or hydraulic means for adjusting the height of the load-bearing face. In particular, electric-motor-driven spindle hoisting gears, pneumatic or hydraulic cylinders, or the like can be considered.

A variant of the loading car of the invention, in which the loading means has at least two segments, which are connected to one another in articulated fashion by means of spring elements and/or other mechanical connections, is quite particularly advantageous and can be used universally.

The advantage of a loading means comprising a plurality of segments as described above is that the loading means on moving in the loading direction, for instance upon moving from a rolling face of the loading car into a railroad car, can adapt to any curvature that the floor of the railroad car may have.

The adaptation is done by means of an elastic deformation of the spring elements between the various segments of the loading means, and the longitudinal axes of the segments, extending in the loading direction, form angles of up to several degrees with the respective curvature of the floor.

It is highly advantageous to embody the spring elements as leaf springs, especially spring steel leaf springs, which for instance connect the load-bearing faces of adjacent segments of the loading means to one another. In addition or as an alternative to the spring elements, adjacent segments can be joined together via separate joints, which when the loading means is being moved transmit tensile and shear forces that occur.

In a loading car of the invention, for moving the loading means back and forth in the loading direction, it is provided in a further embodiment that the loading means has at least one drive recess for receiving a counterpart element, which counterpart element is drivable in the loading direction by means of a loading means drive mechanism. The counterpart element is introduced into the drive recess of the loading means, so that driving the loading means via the loading means drive mechanism is effected by the resultant coupling of the counterpart element and the loading means.

Introducing the counterpart element into the drive recess and removing it again are typically done by a linear final control element, such as an electromagnet.

The loading means drive mechanism can for instance be embodied as a chain drive. However, it is also possible to provide a linear drive, such as a long-stroke cylinder or the like. A clutch or other means for limiting the tensile and driving forces that occur in the loading means drive mechanism is also expedient, so that when a loading means is mechanically blocked, destruction of the drive components from exceeding a maximum allowable driving force can be averted along with the attendant risk to the environment.

Having more than one drive recess is highly expedient for speeding up a loading process, since a counterpart element that is not yet introduced into a drive recess or not yet located opposite a drive recess must on average travel a shorter distance to reach a drive recess.

An especially advantageous embodiment of the invention is characterized in that the loading means has two drive recesses, and that the drive recesses are each disposed in opposite end regions of the loading means.

As a result, the loading means can be moved over virtually its entire length by the loading means drive mechanism from the rolling face of the loading car onto a loading face or into a railroad car or the like, without the counterpart element's having to be introduced into a different drive recess in the meantime. The two drive recesses also assure that the loading means can be moved on both sides from the rolling face of the loading car.

As an alternative to the above-described loading means drive mechanism by means of a drive recess in the loading means and a corresponding driven counterpart element, in a further embodiment of the invention it is provided that the loading means itself has drive means, preferably electric motors, for driving in the loading direction.

In this variant of the invention, it is for instance possible to provide an electric motor in every segment or only in some segments or one segment of the loading means, and this electric motor then drives the rollers of the loading means directly via a gear.

Analogously, a chain drive of the loading means is also conceivable, in which the drive means are likewise integrated directly with the loading means.

Another embodiment of the loading car of the invention is characterized in that the loading means has at least one locking recess, with which the loading means, in cooperation with a locking counterpart element provided on the loading car, can be locked against motions in the loading direction.

Locking the loading means in accordance with the invention prevents the loading means from being moved unintentionally and can for instance be used to secure the loading means whenever the counterpart element of the loading means drive mechanism is removed from whichever drive recess is being used at the moment, for instance for the sake of changing from one drive recess to another.

A further increase in the flexibility of the loading car of the invention is obtained by providing that a conveyor device on the loading car is provided, on which the load rests when the load-bearing face is lowered, and that the load is movable back and forth by means of the conveyor device in the loading direction relative to the loading means.

In that case, by lowering the load-bearing faces of the loading means, the load can be set down on the conveyor device and moved by means of it relative to the loading means.

This makes it possible to load the loading car of the invention from a first side and to unload it from the side opposite the first side in terms of the loading direction.

Since in use for instance in a loading means drive mechanism integrated into the loading car, using the aforementioned counterpart element and the drive recesses cooperating with it, the loading means can never be moved all the way out, that is, with its full length, of the loading car or away from the rolling face thereof, and furthermore a slight spacing always remains between the readiness zone or the target zone and the rolling face, the loading means can typically, before the load is lifted, not move so far beneath the load that the load is located centrally above the loading means in the loading direction. Instead, the load is positioned a certain distance away from the center of the loading means in the direction of the loading side of the loading car.

In unloading from the opposite unloading side, a load placed in this way cannot be unloaded centrally in the target zone, since besides the aforementioned non-central positioning upon unloading, there is the further fact that the loading means can also not be moved all the way out of the loading car or away from its rolling face in the unloading direction.

To overcome this problem, the load not centrally placed on the loading means is set down on the conveyor device by lowering of the load-bearing face and is shifted by the conveyor device relative to the load-bearing face until the load is oriented centrally to the loading means, or is even located on the half of the loading means that is on the unloading side, so that in unloading it can be positioned centrally in the target zone.

In a loading means that is provided with its own drive means, this correction in position of the load on the loading means can be omitted, since the loading means can be moved farther out of the loading car or farther away from it. Nevertheless, the possibility of correcting the load position by means of the conveyor device still exists.

An especially expedient embodiment of the invention provides that the conveyor device is embodied as a chain conveyor, as a result of which many such loads can be moved without further adaptation to the conveyor device.

A very highly advantageous embodiment of the present invention provides that the loading means is adjustable in height.

In transferring a load into and out of railroad cars, the height adjustability is especially advantageous, since there are many different types of railroad car in existence, whose loading height varies, among other factors in accordance with the load and in accordance with the type of floor a railroad car may have.

Another variant of the invention is characterized in that two or more loading means are provided, and that the loading means are each individually adjustable in height. Preferably, the loading means are placed side by side in terms of the loading direction, so that both loading means are simultaneously movable to beneath the load or can simultaneously lift the load.

Besides the greater possible lifting force, this results in a more-stable disposition of the load on the loading means.

Since each loading means is individually adjustable in height, the loading car or the loading means can even be adapted to loading faces that are inclined in the travel direction, that is, transversely to the loading direction; as a result, mechanical stresses on the load in moving the loading means from the loading face onto the rolling face are reduced.

In particular, because of their individual height adjustment, the loading means are optimally adaptable to the loading faces of railroad cars, which can have a slanting floor if a load is unevenly distributed in the travel direction.

The height adjustment of the loading means is effected, in one embodiment of the invention, advantageously with spindle hoisting gears.

To enable automatic detection of the height or the loading means or of a difference in height between the loading means and a reference plane, a likewise highly advantageous embodiment of the invention preferably has means for detecting the height of the loading means and/or means for detecting a difference in height between the loading means and a reference plane, in particular an edge feeler with reflected-light gates or the like.

Another advantageous embodiment of the loading car of the invention is characterized in that the loading car has an electric drive mechanism for moving it back and forth in the travel direction. Especially for semiautomatic or fully automatic operation, it is attractive that the loading car moves on rails of a loading track. A further variant of the invention provides that the loading car draws current from an overhead line disposed in the travel direction or along the loading track.

In an automatic loading mode, the loading car ascertains its position from rotation sensors mounted on wheels of the loading car and/or from image processing systems that detect patterns placed in the travel direction.

By means of the image processing systems, it is also possible to ascertain a relative position, for instance between the loading car located on a loading track and a freight train with cars that is on a track beside it. For instance, each car of the freight train is provided with a plurality of symbols, on the basis of which the image processor of the loading car can ascertain the position of the loading car relative to the respective railroad car.

For further attaining the object of the present invention, the use of a loading car of one of claims 1-19 in a loading system of the type defined at the outset is proposed.

A very highly advantageous embodiment of the loading system of the invention is characterized in that at least one modular loading stand is provided for receiving at least one load carrier receiving a load. Because of its modular nature, the loading stand can be lined up arbitrarily with identical or similar elements. The loading stand stands on the ground in the readiness zone and has levelling screws on its feet, for instance to compensate for unevenness of the ground in the readiness zone.

In a further embodiment of the present invention, the loading stand has load-bearing regions, on which the load carriers can rest. To stabilize the load carrier and to enable accurate positioning of the load carrier on the loading stand, a further variant of the loading stand, in the load-bearing regions, has centering means which secure the load carrier resting on it against slipping.

While the loading stand itself preferably has a steel construction, the centering means are preferably of hard plastic.

A further very advantageous variant of the invention provides that the loading stand has rolling faces, on which a loading means of the loading car is movable beneath the support face of a jacked-up load carrier. This makes a loading car located next to the loading stand possible for moving the loading means beneath the load on the loading stand or beneath the load carrier and lifting it or them. As they move beneath the jacked-up load carrier, the loading means of the loading car brace themselves in a known manner on the rolling faces of the loading stand.

In a further embodiment of the invention, in addition to the rolling faces, running faces are also provided on the loading stand, for a resupply system, which is movable on the running faces of the loading stand below the load or the load carrier and preferably in the loading direction and which can lift the load or the load carrier as needed and move it relative to the loading stand.

Another refinement of the loading system of the invention is characterized in that the readiness zone has at least one buffer for temporary storage of a load to be transferred. In the buffers, empty load carriers or load carriers carrying a load can also be stored temporarily.

It is very particularly advantageous to use stackable and collapsible load carriers; at least two load carriers can also be stacked one on the other after a load has been placed on them. In the empty state, the load carriers are preferably collapsible to reduce the space they require, and a plurality of collapsed load carriers can be stacked one on the other. The stacked load carriers can also be jacked up on a loading stand.

In another advantageous embodiment of the invention, the readiness zone extends in the travel direction. If a plurality of buffers disposed in the travel direction or along the tracks of the loading car are provided in the readiness zone, then the loading car can access the various load carriers by approaching the various buffers. This also increases the buffer capacity of the loading system.

A highly economical configuration of the buffers is obtained in a further embodiment of the invention in which a plurality of buffers are disposed side by side and/or in line with one another in terms of the travel direction.

For instance, if two buffers, which each have a plurality of loading stands, are disposed side by side in the travel direction, then the resupply system can be moved back and forth from the first buffer to the second buffer, since the running faces provided on the respective loading stands for the resupply system adjoin one another directly both between the loading stands of one buffer and between loading stands of adjacent buffers. In this way, a load carrier can be brought from a buffer that is not directly adjacent the loading track into a buffer that is located directly at the loading track and can therefore be unloaded from the loading car using the loading means. An empty buffer is then refilled with a load by the resupply system or with collapsed empty and/or stacked load carriers.

Further characteristics, possible applications, and advantages of the invention will become apparent from the ensuing description of exemplary embodiments of the invention, which are shown in the figures of the drawing. All the characteristics described or shown are the subject of the invention both individually or in arbitrary combination, regardless of their summarizing in the claims or the claims dependencies and regardless of their wording in the description and how they are shown in the drawing.

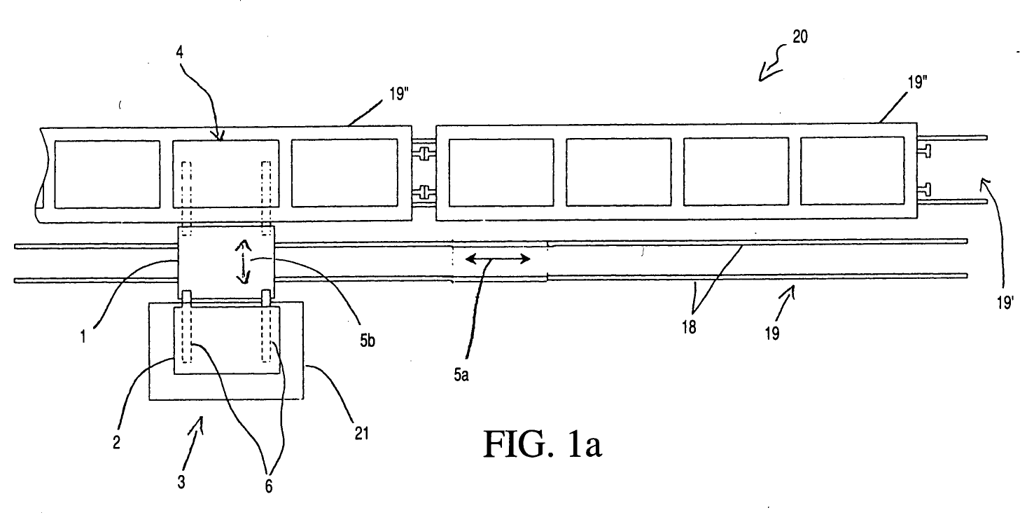

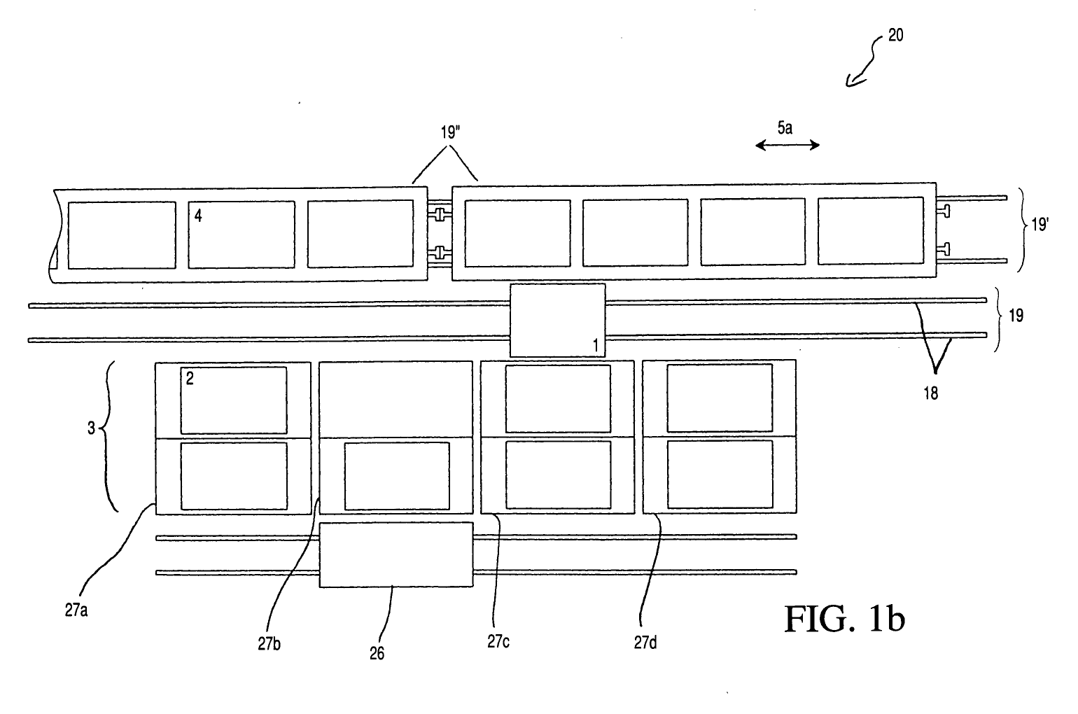

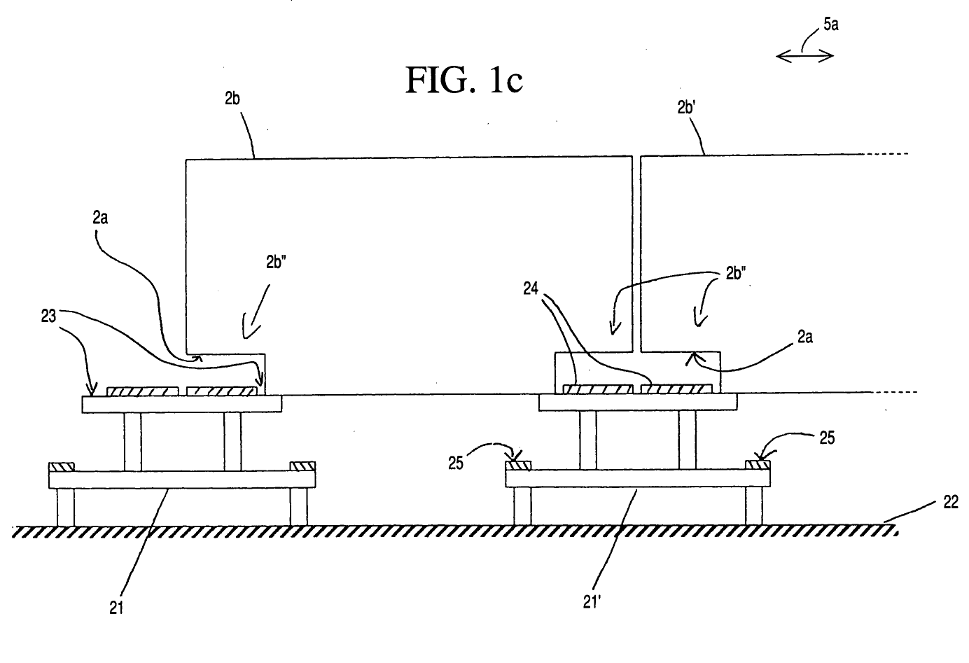

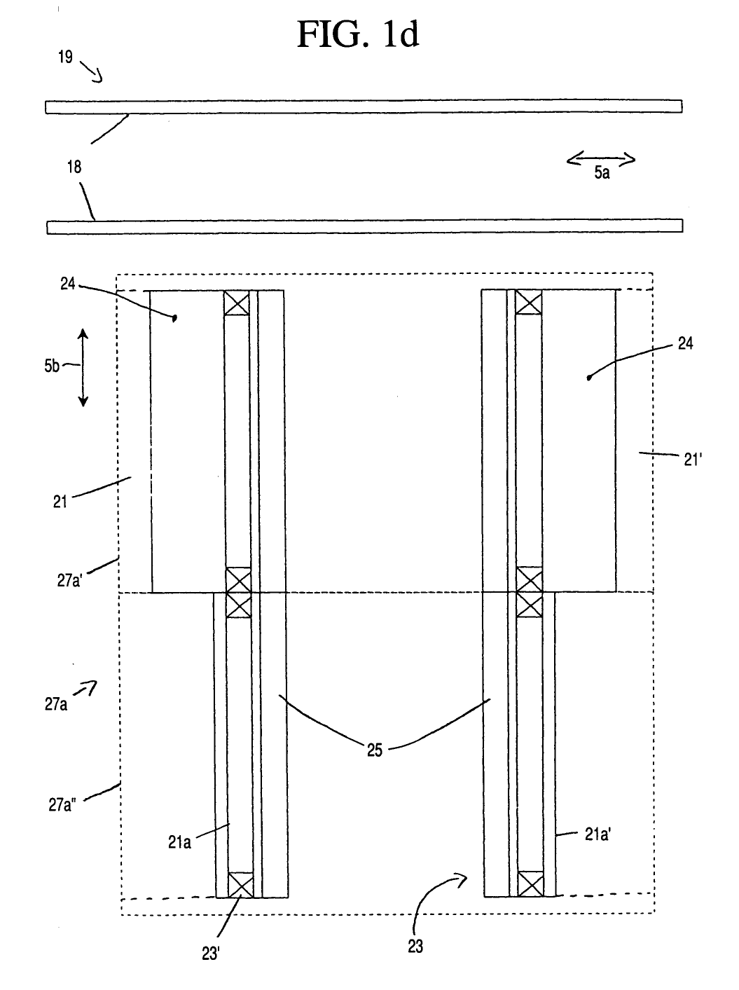

FIG. 1a shows an embodiment of the loading system of the invention in plan view;

FIG. 1b shows a second embodiment of the loading system of the invention;

FIG. 1c shows an embodiment of a loading stand 21 of the invention with a jacked-up load;

FIG. 1d shows a buffer 27a from above;

FIG. 1e is a side of the resupply system looking in the travel direction;

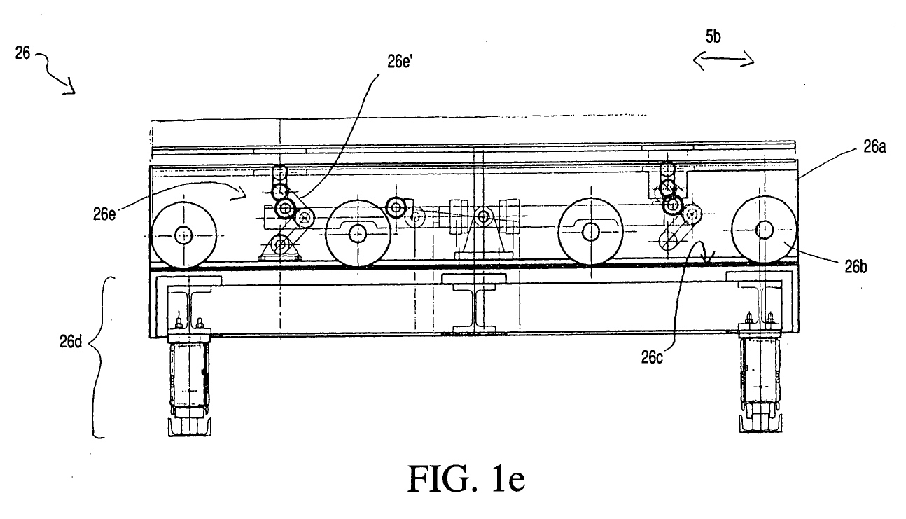

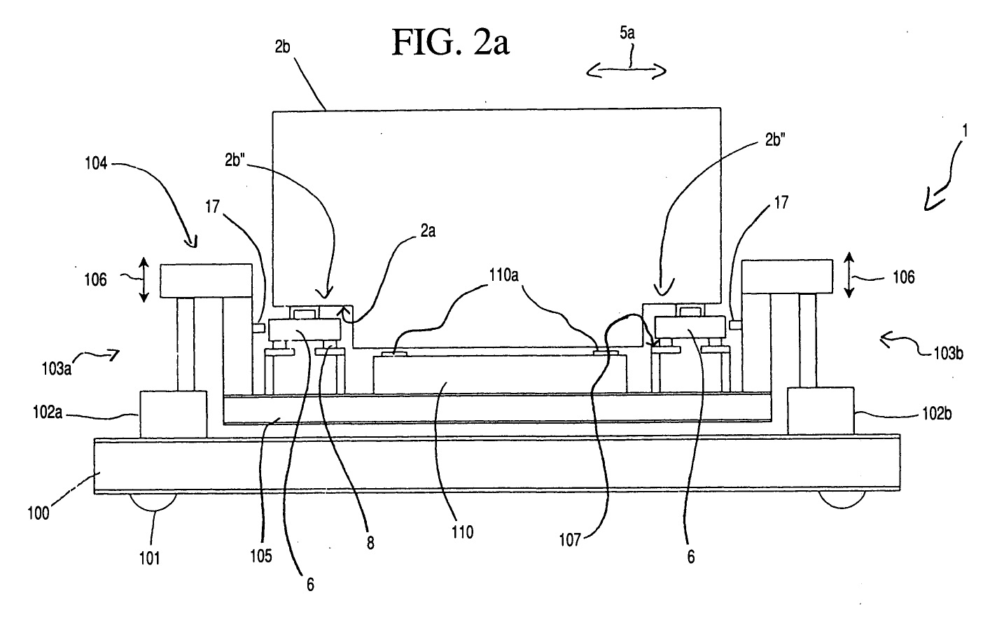

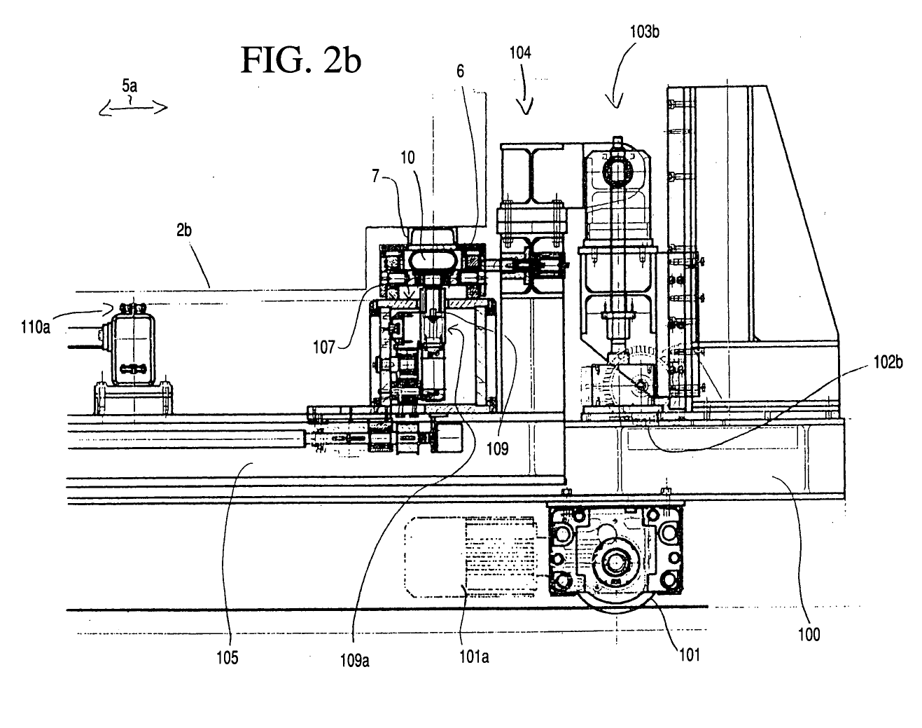

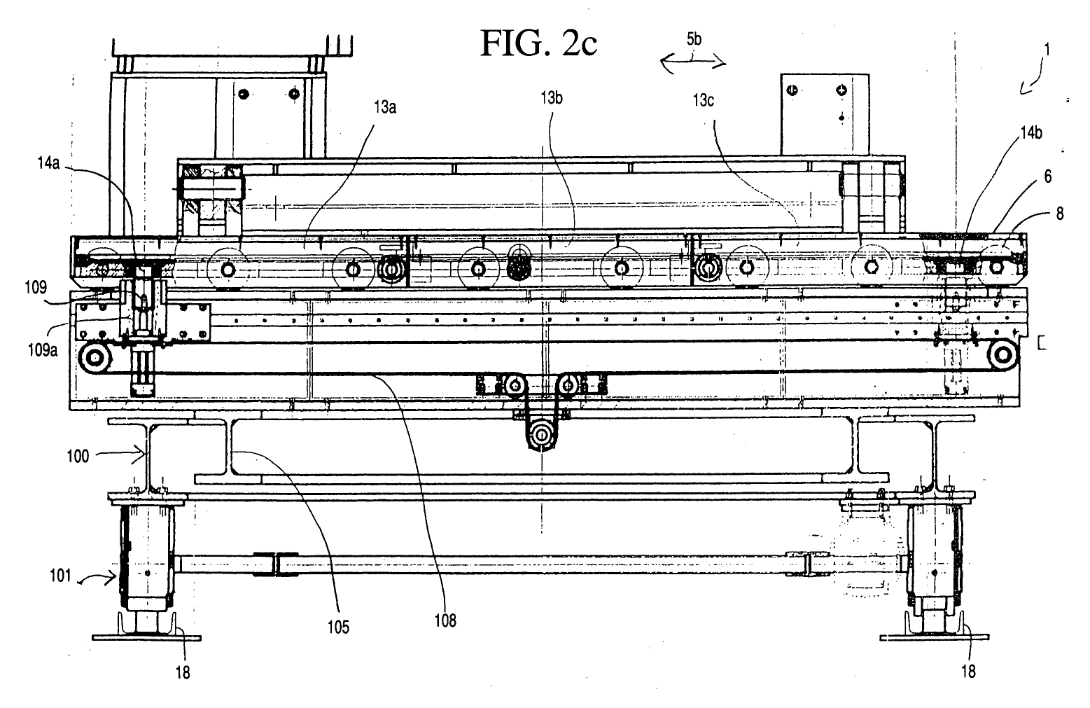

FIG. 2a schematically shows a highly simplified side view of one embodiment of the loading car 1 of the invention with a raised load carrier 2b;

FIG. 2b, partly in cross section, shows a detail of the right-hand part of the loading car 1 of FIG. 2a, looking in the loading direction;

FIG. 2c, partly in cross section, shows a detail of the left-hand part of the loading car 1 of FIG. 2a, looking in the travel direction;

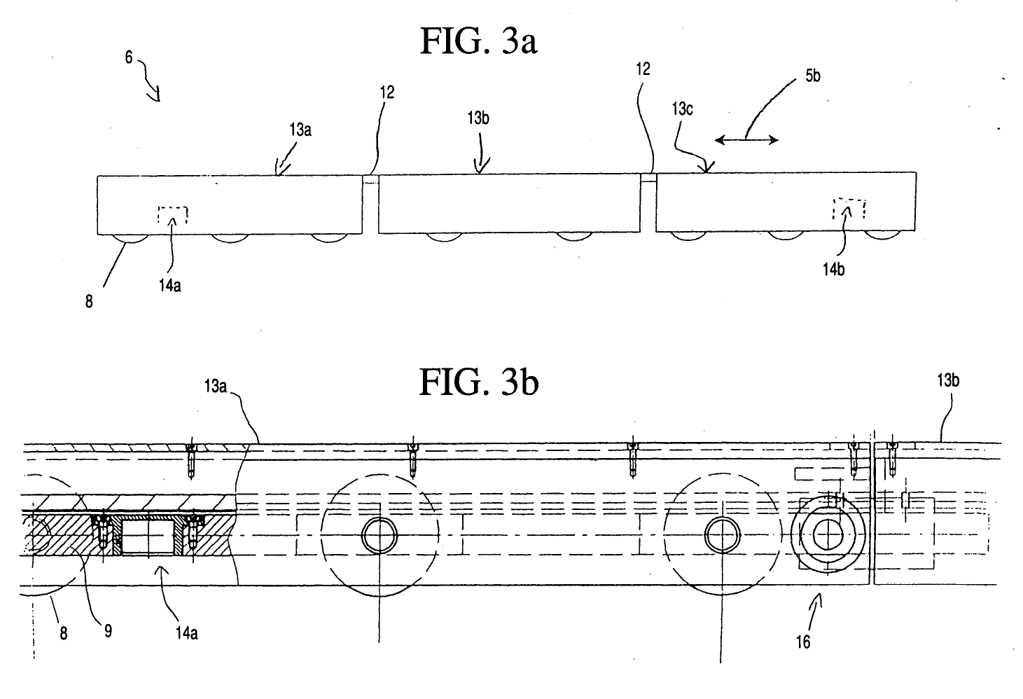

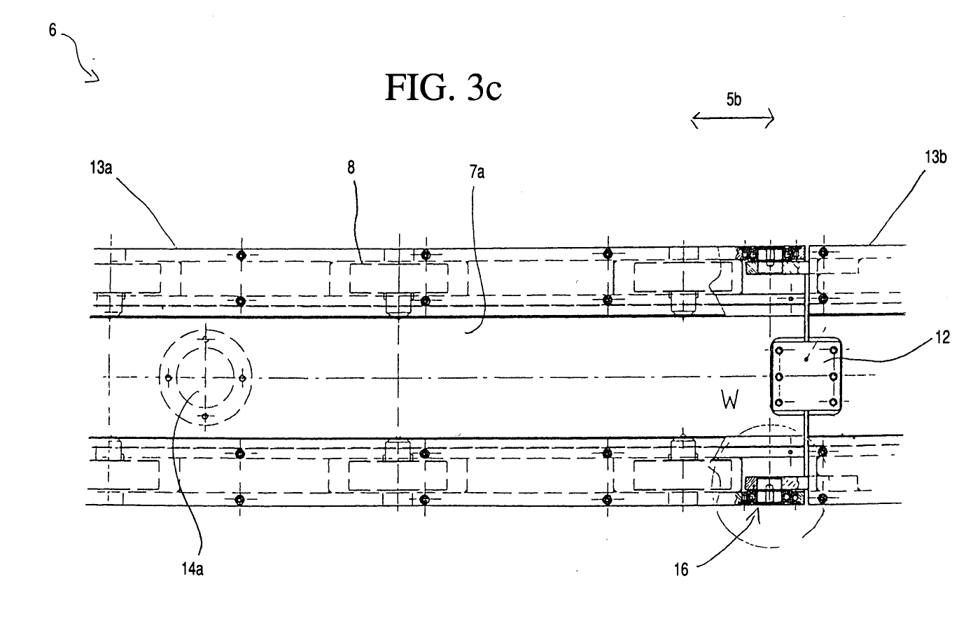

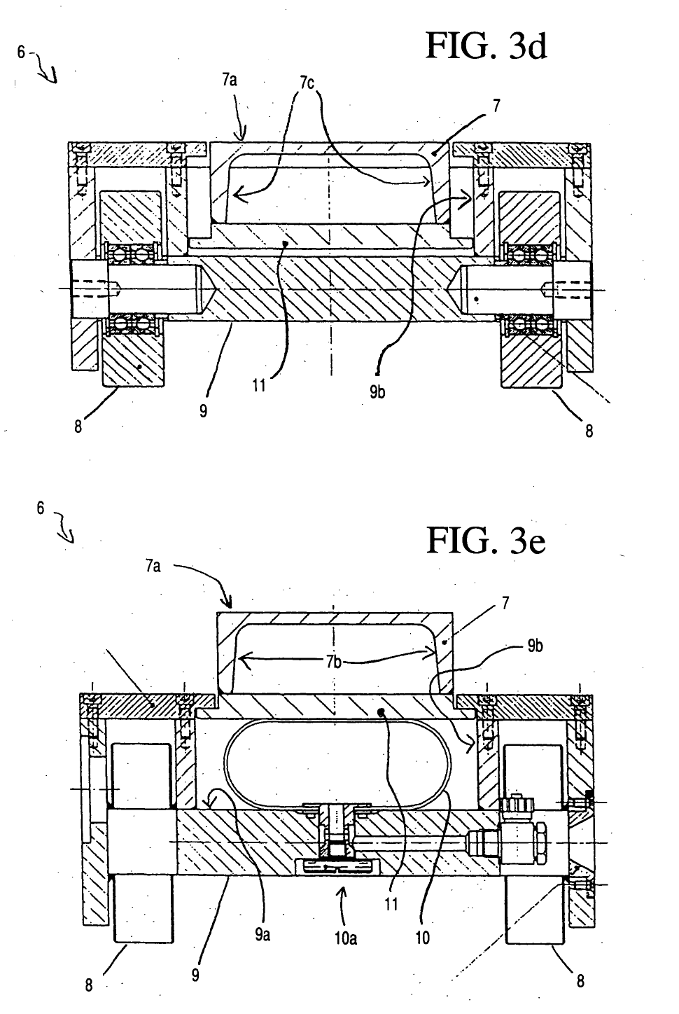

FIG. 3a schematically shows a side view of an embodiment of the loading means 6;

FIG. 3b, partly in cross section, shows a detail of part of the loading means 6 of FIG. 3a;

FIG. 3c, partly in cross section, shows a detail of the loading means 6 of FIG. 3a in plan view;

FIG. 3d shows a fragmentary cross section through the loading means 6 with the load-bearing face 7a lowered, at a first point;

FIG. 3e shows a fragmentary cross section through the loading means 6 with the load-bearing face 7a raised, at a second point; and

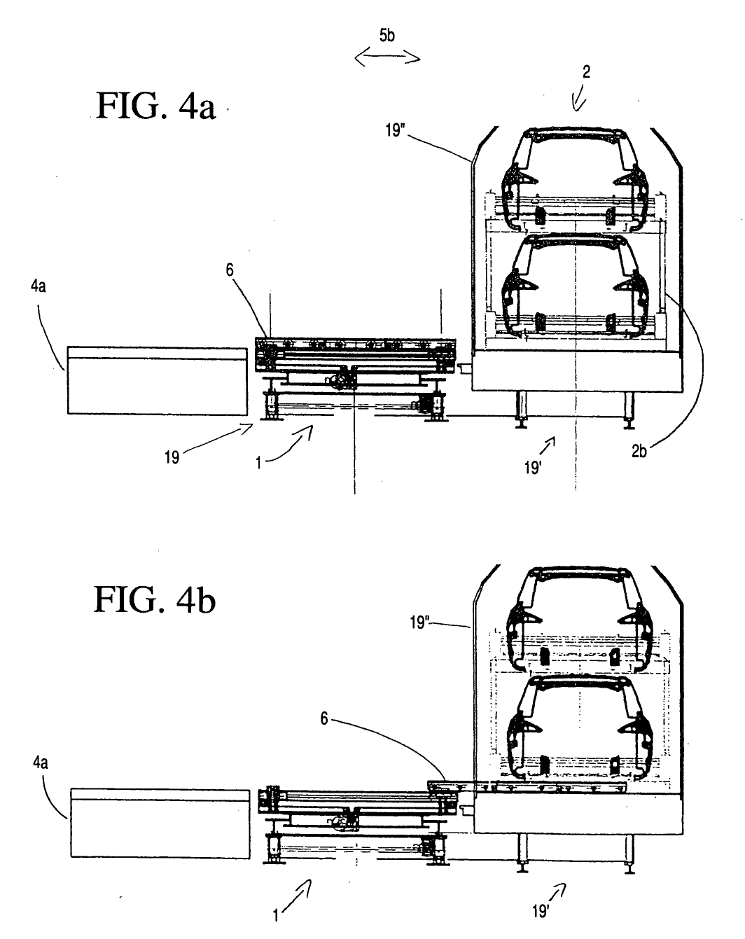

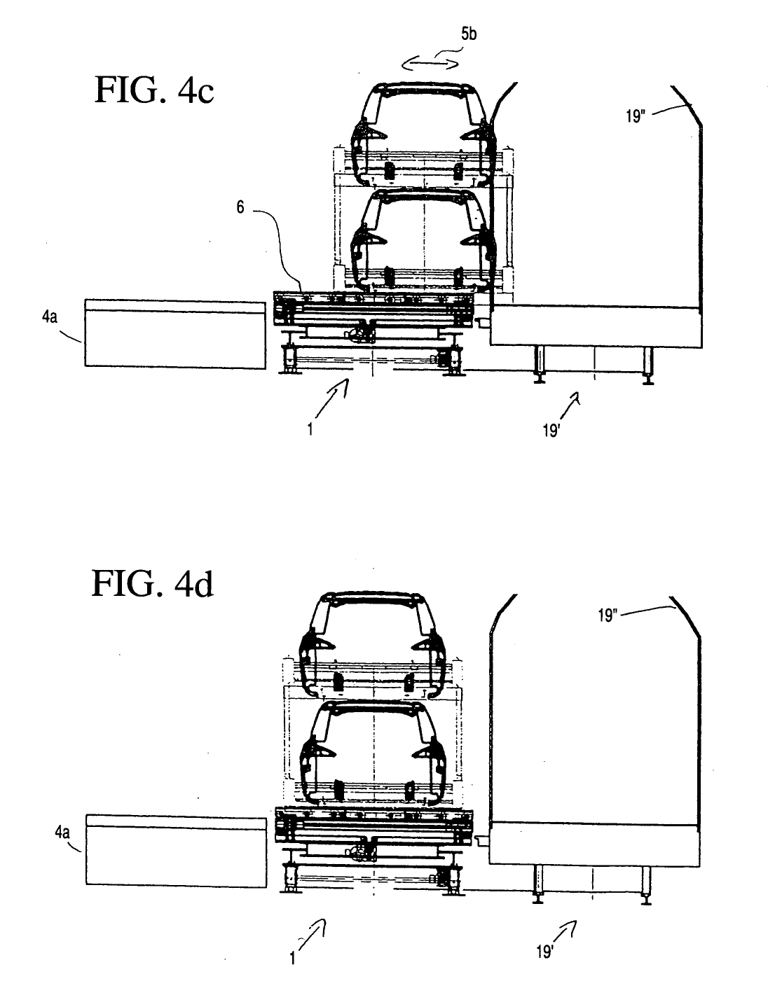

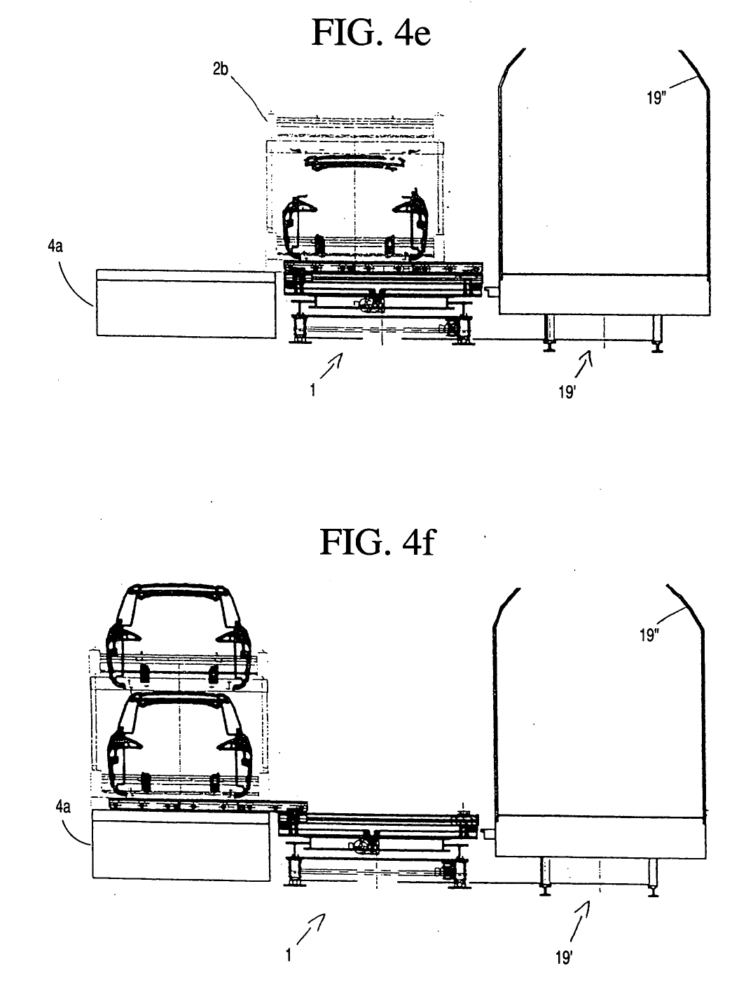

FIGS. 4a-f show six phases of a loading operation from a railroad car onto a loading ramp.

The loading system 20 shown in FIG. 1a has a loading car 1, which can move back and forth on the loading track 19 in a travel direction represented by the double arrow 5a. The loading track 19 is formed by the rails 18.

Extending parallel to the loading track 19 is a railroad track 19′, on which freight cars 19″ can travel.

The loading car 1 loads the load 2, held in readiness in the readiness zone 3, into the target zone 4 in a manner to be explained hereinafter by means of a loading means 6 that is movable back and forth in a loading direction 5b. The target zone 4 is shown here in the form of a freight car 19″, which is parked on the railroad track 19′.

FIG. 2a shows the loading car 1 highly simplified, in a side view, along with a loaded load carrier 2b, which is capable of receiving an arbitrary type of load 2, such as machine parts or auto bodies. The loading direction 5b—see FIG. 1a—is perpendicular to the plane of the drawing in FIG. 2a, and the travel direction of the loading car 1 is again represented by the double arrow 5a.

As can be seen from FIG. 2a, the loading car 1 has a base frame 100, on which wheels 101 and electric motors 101a (not shown in FIG. 2a; see FIG. 2b) that drive the wheels 101 are mounted.

Two spindle drives 102a, 102b, which are each part of a respective spindle hoisting gear 103a and 103b, are located on the base frame 100 of the loading car 1. The spindle hoisting gears 103a, b carry a loading frame 105, which is retained via angle supports 104, and the height of this frame relative to the base frame 100 is variable via the spindle hoisting gears 103a, b. In this way, the loading frame 105 can be moved to a predetermined height above the ground in a continuously variable way and with high accuracy. This height adjustability of the loading frame 105 is represented in FIG. 2a by the double arrows 106.

The fact that each spindle hoisting gear 103a, b is individually adjustable is especially advantageous; thus the loading frame 105 can also be moved out of its parallel position to the base frame 100 and can thus be inclined relative to the ground in the travel direction 5a.

On the loading frame 105 of the loading car 1, two loading means 6 known as skates are provided, which are movable with rollers 8 on rolling faces 107, provided for the purpose, of the loading car 1 in the loading direction, or in other words perpendicular to the plane of the drawing in FIG. 2a.

As indicated in FIG. 1a by the dashed and dot-dashed lines, the skates 6 can be moved out of the loading car 1 and into it in the loading direction 5b on both sides of the loading car 1. It is thus possible to load the loading car 1 on one side of the loading track 19 and to unload the loading car 1 on the other side of the loading track, or vice versa.

The drive of a skate 6 is described below with reference to the detail shown in FIG. 2c, which is a fragmentary cross section through the loading car 1, looking toward the skate 6 shown on the left-hand side of FIG. 2a.

The skate 6 is drive by a drive mechanism, which is solidly integrated with the loading car 1 and has a toothed belt 108, extending parallel to the skate 6, onto which belt a counterpart element 109 is secured together with a final control element 109a. By means of the final control element 109a, the counterpart element 109 can be moved back and forth in a vertical direction in terms of FIG. 2c, so that the counterpart element 109 can be introduced from below into one of the two drive recesses 14a, b of the skate 6 and removed from it again.

The drive recesses 14a, b located on the underside of the skate 6 can also be seen in the schematic side view of the skate 6 shown in FIG. 3a. The drive recesses 14a, 14b are located on respective opposite ends of the skate 6.

From the fragmentary cross section in FIG. 3b, it can be seen that the drive recess 14a, like the drive recess 14b (not shown in FIG. 3b), is located directly in a carriage 9 of the skate that is supported on the rollers 8 of the skate 6, and as a result, a reliable introduction of the driving force of the toothed belt 108 (FIG. 2c) through the counterpart element 109 into the carriage 9 is assured. The drive recess 14a can also be seen from the plan view in FIG. 3c.

FIGS. 4a-4f show six phases in a typical loading operation from a railroad car 19″, parked on the railroad track 19′, to a loading ramp 4a, using the loading car 1.

Initially, the load 2 accommodated in a load carrier 2b is located in the railroad car 19″; see FIG. 4a.

The loading car 1 moves in the travel direction 5a (see FIG. 1), which in FIG. 4a is perpendicular to the plane of the drawing, on the loading track 19 to the load 2; the loading car 1 ascertains its position relative to the load 2, or to the railroad car 19″, from symbols applied to the load 2 and/or to the railroad car 19″, which are evaluated with an image processing system, not shown. The symbols are comparable to two-dimensional bar codes for identifying products and can additionally contain information about the car 19″ and/or the load 2.

Once the loading car 1 has positioned itself precisely in front of the load 2 in terms of the travel direction 5a, the height of the loading frame 105 (FIG. 2a) and thus also the height of the rolling faces 107 of the loading car 1 are adjusted with the spindle hoisting gears 103a, b in such a way that the rolling faces 107 are located at the same height as the floor of the railroad car 19″.

Detecting the height of the floor of the railroad car is done with laser-based reflected-light gates, embodied as edge feelers, or the like.

As soon as the floor of the railroad car and the rolling faces 107 of the loading car 1 are at the same height, the skates 6 of the loading car 1 are moved onto the floor of the railroad car, on which they are braced—as in the retracted state on the rolling faces 107 of the loading car 1. As a result, unlike the situation with a forklift, for instance, the loading car 1 need not absorb any torque caused by the force of gravity of the load 2.

For moving a skate 6 from the loading car 1 into the car 19″, the counterpart element 109, driven by the toothed belt 108 (FIG. 2c), is introduced into the drive recess 14a of the skate remote from the railroad car, that is, the left-hand drive recess in terms of FIG. 4a, and is then entrained by the toothed belt 108 until the skate 6 has moved maximally far away from the loading car 1 into the car 19″.

This situation is shown in FIG. 4b. Moreover, the skate 6 cannot be moved outward by the counterpart element 109 (FIG. 2c), because of the toothed-belt drive. In a skate 6 that has its own drive mechanism, in which the rollers 8 are for instance driven directly by an electric motor, it is entirely conceivable for the skate 6 to be movable all the way away from the loading car 1. The distance the skate is moved away depends in this case only on the length of any supply lines that may be present.

Typically, even in the case of already badly worn, uneven car floors, no aids are needed in moving the skate 6, for instance for guiding it; nevertheless, a folded metal sheet can for instance be secured to the floor of the railroad car in order to stabilize and guide the skate 6 as it is being moved into the railroad car 19″.

To enable moving the skates 6 to beneath the load 2 in the railroad car 19″, or beneath the load carrier 2b that receives the load, the load carrier has corresponding recesses 2b″; see FIG. 2a.

As soon as a skate 6 is located below the load carrier 2b, as shown in FIG. 4b, a hose 10 (FIG. 3e) located in the skate 6 is inflated, via a compressed-air supply, not shown, of the loading car 1. The compressed-air supply is connected to the hose 10 via the compressed-air connection 10a located in the carriage 9.

When the hose 10 is subjected to compressed air, the volume occupied by the hose 10 increases, and an intermediate plate 11, resting on the top of the hose 10 and guided in the side walls 9b of the skate 6, is pressed upward, thereby raising the U-shaped profile 7 resting on the intermediate plate 11.

The bottom side, pointing upward in FIG. 3e, of the U-shaped profile 7 forms a load-bearing face 7a, which upon inflation of the hose 10 is pressed from below against a support face 2c of the load carrier 2b, which face is located in the region of the recesses 2b″—see FIG. 2a—and as a result the load carrier 2b is raised. In this situation, both the weight of the skate or skates themselves and the weight of the load carrier 2b (when it is carrying a load) rest on the skate 6 or skates 6.

After the load carrier 2b has been lifted, the skates 6 are moved back onto the loading car 1, which is achieved by a reversal of the direction of the toothed belt 108; see FIG. 2c. After the skates 6 have been moved onto the loading car 1, the situation shown in FIG. 4c is reached, in which it can be seen that the load 2 does not rest centrally on the skates 6 in terms of the loading direction 5b.

The reason for this is that until now, the skates 6 could not be moved all the way away from the loading car 1 into the freight car 19″ so as to be positioned centrally below the load 2.

To vary the location of the load 2 on the skates 6, the load 2 is first lowered to the loading car 1, which is effected by venting the hose 10 of FIG. 3e via a venting system. The venting can be done solely by way of the force of gravity of the load 2 acting on the hose 10 or by additional evacuation of the hose 10, and in the latter case faster lowering of the load-bearing faces 7a and of the load 2 resting on them is attainable.

FIG. 3d shows a cross section through the skate 6 in the vented state.

When the load 2 is loaded onto the loading car 1, the load carrier 2b comes to rest on conveyor chains 110a of a chain conveyor 110, schematically shown in FIG. 2a, that is located between the two skates 6. In the detail shown in FIG. 2b, a chain 110a of the chain conveyor 110 can be seen on the left.

The load-bearing faces 7a of the skates 6 are lowered so far that they no longer touch the load carrier 2b, and so this load carrier is now supported only by the chains 110a of the chain conveyor 110.

The chain conveyor 110 shifts the load carrier 2b in the loading direction 5b from the position on the skates 6, shown in FIG. 4c to the middle position shown in FIG. 4d, and finally to the position shown in FIG. 4e, in which the load carrier 2b is located to the left of the center of the skates 6.

Because the drive mechanism limits the travel distance of the skates 6 on both sides, this leftward shift of the load carrier 2b relative to the skates 6 is required in order to allow the load carrier 2b to be set down centrally on the loading ramp 4a; see the remarks describing FIGS. 4b and 4c.

Beginning at FIG. 4e, the load carrier 2b still resting on the chain conveyor 110 is lifted from the load-bearing faces 7a by inflation of the hose 10 (FIG. 3e) of the skates 6 and thus loses contact with the chains 110a (FIGS. 2a, 2b) of the chain conveyor 110, whereupon the skates 6, along with the load, can be moved to the left onto the loading ramp 4a as shown in FIG. 4f.

Before that, however, the counterpart element 109—FIG. 2c—must be removed from the drive recess 14a on the left and introduced into the drive recess 14b on the right, so that the skate 6 is movable leftward onto the loading ramp 4a.

As soon as the load carrier 2b along with the load 2 has been moved centrally onto the loading ramp 4a thanks to the skates 6, the hoses 10 of the skates 6 are vented to enable the load carriers 2b and the skates 6 to be moved back onto the loading car 1.

For securing a skate 6 located on the loading car 1, at least one locking recess 16 is provided, disposed laterally on the skate 6—see FIGS. 3b and 3c—into which recess a locking counterpart element 17 (FIG. 2a), disposed on the angle support 104 of the loading car 1 and movable linearly by means of a final control element can be introduced, in order to prevent the skate 6 from moving or rolling away on the rolling face 107 of the loading car 1 while the counterpart element 109 (FIG. 2c) belonging to the drive of the skate 6 is out of engagement with one of the drive recesses 14a, b of the skate 6.

In one embodiment of the invention, the skate 6, as shown in FIG. 3a, has a plurality of segments 13a, 13b, 13c, which are joined to one another by leaf springs 12 (see also FIG. 3c) of spring steel. This embodiment has the particular advantage that in the loading operation, the skate 6 can adapt to a floor or ground curvature extending in the loading direction 5b by elastic deformation of the leaf springs 12. As a result, the loading car 1 can even transfer loads 2 from uneven ground or floors. It is conceivable for the tensile and shear forces, required for moving the skate 6 and introduced into the carriage 9 of the skate 6 by the toothed belt 108 (FIG. 2c) via the counterpart element 109, to be transmitted solely by means of the leaf springs 12 between the segments 13a, b, c. In addition to the leaf springs 12, or as an alternative, a jointed connection for transmitting force between each two adjacent segments 13a, b, c of the skate 6 is also possible.

The loading car 1 described above is provided in a loading system of FIG. 1a, as already noted at the outset, in order to pick up the load 2 furnished in the readiness zone 3, a load that is typically located in load carriers 2b, and carry it to a target zone 4.

To make the loading operation as efficient as possible, in an embodiment of the loading system 20 shown in FIG. 1b, a plurality of buffers 27a, 27b, 27c, 27d are disposed in the readiness zone 3 and pick up the load 2 to be loaded from the loading car 1.

The view in FIG. 1d shows the buffer 27a of FIG. 1b from above and enlarged; the load 2 in FIG. 1d is not shown. The buffer 27a has two buffer spaces 27a′ and 27a″, which each afford parking space for loading stands 21 shown from the side in FIG. 1c.

The loading stand 21 comprises a top part, which has load-bearing regions 23 and rolling faces 24 located between these regions, on which regions and faces a skate 6 (not shown) of the loading car 1 is movable back and forth in the loading direction, or in other words perpendicular to the plane of the drawing in FIG. 1c. The loading stand 21 furthermore has a lower part provided with feet, and the feet are equipped with levelling screws to compensate for unevenness of the ground or floor 22.

The rolling faces 24 are located in the region of the recesses 2b″ of the jacked-up load carriers 2b, 2b′, so that the skates 6 (FIGS. 3d, 3e) are movable, with lowered load-bearing faces 7a, to beneath the load carrier 2b or 2b′, respectively, and can lift it as described already and carry it away.

As can be seen from FIG. 1c, the loading stand 21′ is symmetrical and is embodied such that both load carriers 2b and 2b′ can brace themselves simultaneously on the loading stand 21′. Adjacent loading stands 21, . . . each carry the respective other sides of the load carriers 2b, 2b′.

In addition to the rolling faces 24, the loading stand 21 also has running faces 25, which as shown in FIG. 1c extend below the rolling faces 24 and farther inward, relative to the center of the load carrier, in the travel direction 5a.

On the running faces 25 of the loading stands 21, a transport unit 26a (FIG. 1e) which is part of a resupply system 26 shown in FIGS. 1b and 1e can be moved to beneath the jacked-up load carriers 2b.

The transport unit 26a is also movable in the loading direction 5b on rollers 26b on a rolling face 26c, which is located on top of the part 26d of the resupply system 26 that is connected to the rail.

The disposition of the loading stands 21, 21′, 21a, 21a′ shown in FIG. 1d is especially advantageous; they are placed side by side or in line with one another in such a way that the respective running faces 25 of the right half of the loading stand 21 and 21a are aligned with the running faces 25 of the left half of the loading stand 21′ and 21a′, resulting in an overall running face 25 for the transport unit 26a of the resupply system 26—see FIG. 1e—that extends beneath both buffer spaces 27a′ and 27a″.

Thus the transport unit 26a can be driven downward from the part 26d of the resupply system 26 that is connected to the track, initially onto the loading stands 21a and 21a′ below the first jacked-up load carrier (not shown) and then onto the loading stands 21 and 21′ below the second jacked-up load carrier (not shown)—that is, from the buffer space 27a″ to the buffer space 27a′—and back again.

The transport unit 26a is equipped with lifting means 26e for lifting a load carrier 2b, located above it, so that it can lift a load carrier 2b that has been jacked up on the loading stands 21a, 21a′, 21, 21′, move it onto the loading stands of the adjacent buffer space, and set it down thereon. For this purpose, the lifting means have toggle joint mechanisms 26e′.

From the loading stands 21, 21′, the loading car 1 (see FIG. 1a) moving on the loading track 19 can, by means of its skate 6 directly carry away a load carrier 2b that has been jacked up there. To that end, the skates 6 must be moved in a known manner, with load-bearing faces 7a initially lowered (FIG. 3d), on the rolling faces 24 to beneath the load carrier 2b jacked up in the buffer space 27a′, and then lift it and put it onto the loading car 1.

The buffer space 27a″ is not directly accessible to the loading car 1 with its skates 6 directly from the loading track 19, and therefore the loading stands 21a, 21a′ located in the buffer space 27a″ do not need any rolling face 24 for the skates 6.

In the loading system 20 of FIG. 1b, the transport unit 26a of the resupply system 26 brings load carriers 2b, located on buffer spaces (such as 27a″ from FIG. 1d) remote from the loading track, to the respective adjacent buffer spaces (such as 27a′ in FIG. 1d) toward the loading track; from there the loading car 1 can retrieve the load carrier 2b itself by means of skates 6 and transfer it onward.

The resupply unit 26 is also provided, at a point not shown, with new load carriers 2b to be loaded, which as described are transported by means of the transport unit 26a, to free buffer spaces along the loading track 19.

In this way, the resupply of load carriers 2b for the loading car 1 is always assured, and efficient loading from and to railroad cars 19″, for instance, is assured.

In another embodiment, the loading stands 21, in their load-bearing regions 23, have centering means 23′, which engage recesses provided for the purpose (not shown) on the load carriers 2b and secure a load carrier 2b, in the jacked-up state, against slipping/falling down.

As already mentioned, the load carriers 2b are suitable for receiving any type of load 2, so that with the loading system described above, an arbitrary load 2 can be loaded economically and gently.

The energy supply to the loading car 1 through an overhead line (not shown) extending along the loading track 19 is especially advantageous. The loading car 1 advantageously has its own compressor for generating compressed air.

1. A loading car (1), in particular for transferring a load (2) from a readiness zone (3) to a target zone (4), in which the loading car (1) is movable back and forth in a travel direction (5a) and has at least one loading means (6), which is extensible and retractable in a loading direction (5b) located transversely to the travel direction (5a), and in which the loading means (6) has a raisable and lowerable load-bearing face (7a) with which the loading means (6) is movable beneath support faces (2a), characterized in that the loading means (6) has a carriage (9) supported on rollers (8).

2. The loading car (1) of claim 1, characterized in that between a top side (9a) of the carriage (9) and a U-shaped profile (7), open at the bottom, that with its bottom side forms the load-bearing face (7a), a hose (10) that can be subjected to compressed air is provided for adjusting the height of the load-bearing face (7a).

3. The loading car (1) of claim 2, characterized in that between the hose (10) and the U-shaped profile (7), an intermediate plate (11) guided in side walls (9b) of the carriage (9) is provided, on which the legs (7b) of the U-shaped profile (7) preferably rest.

4. The loading car (1) of claim 2 or 3, characterized in that, preferably in the carriage (9), a compressed-air connection (10a) and/or a venting system for supplying the hose (10) with compressed air and for venting it is provided.

5. The loading car (1) of claim 1, characterized in that the loading means (6) has electromechanical and/or pneumatic and/or hydraulic means for adjusting the height of the load-bearing face (7a).

6. The loading car (1) of one of the foregoing claims, characterized in that the loading means (6) has at least two segments (13a, 13b, 13c), which are connected to one another in articulated fashion by means of spring elements (12) and/or other mechanical connections.

7. The loading car (1) of one of the foregoing claims, characterized in that the loading means (6) has at least one drive recess (14a) for receiving a counterpart element (109), which counterpart element is drivable in the loading direction (5b) by means of a loading means drive mechanism (108).

8. The loading car (1) of claim 7, characterized in that the loading means (6) has two drive recesses (14a, 14b); and that the drive recesses (14a, 14b) are each disposed in opposite end regions of the loading means (6).

9. The loading car (1) of one of the foregoing claims, characterized in that the loading means (6) itself has drive means, preferably electric motors, for driving it in the loading direction (5b).

10. The loading car (1) of one of the foregoing claims, characterized in that the loading means (6) has at least one locking recess (16), with which the loading means (6), in cooperation with a locking counterpart element (17) provided on the loading car (1), can be locked against motions in the loading direction (5b).

11. The loading car (1) of one of the foregoing claims, characterized in that a conveyor device (110) on the loading car (1) is provided, on which the load (2) rests when the load-bearing face (7a) is lowered; and that the load (2) is movable back and forth by means of the conveyor device (110) in the loading direction (5b) relative to the loading means (6).

12. The loading car (1) of claim 11, characterized in that the conveyor device (110) is embodied as a chain conveyor.

13. The loading car (1) of one of the foregoing claims, characterized in that the loading means (6) is adjustable in height.

14. The loading car (1) of claim 13, characterized in that two or more loading means (6) are provided; and that the loading means (6) are each individually adjustable in height.

15. The loading car (1) of claim 13 or 14, characterized in that for adjusting the height of the loading means (6), spindle hoisting gears (103a, 103b) are provided.

16. The loading car (1) of one of claims 13-15, characterized in that the loading car (1), preferably in the region of each of the loading means (6), has means for detecting the height of the loading means (6) and/or means for detecting a difference in height between the loading means (6) and a reference plane, in particular an edge feeler with reflected-light gates or the like.

17. The loading car (1) of one of the foregoing claims, characterized in that the loading car has an electric drive mechanism for moving it back and forth in the travel direction (5a).

18. The loading car (1) of one of the foregoing claims, characterized in that the loading car (1) moves on rails (18) of a loading track (19).

19. The loading car (1) of one of the foregoing claims, characterized in that the loading car (1) draws current from an overhead line disposed in the travel direction (5a) or along the loading track (19).

20. A loading system (20) for transferring a load (2) from a readiness zone (3) to a target zone (4) with a loading car (1) of one of the foregoing claims.

21. The loading system (20) of claim 20, characterized in that at least one modular loading stand (21) is provided for receiving at least one load carrier (2b) receiving a load (2).

22. The loading system (20) of claim 21, characterized in that the loading stand (21) has load-bearing regions (23), on which the load carriers (2b) can rest.

23. The loading system (20) of claim 22, characterized in that the loading stand (21), in the load-bearing regions (23), has centering means (23′) which secure a load carrier (2b) resting on it against slipping.

24. The loading system (20) of claim 22 or 23, characterized in that the loading stand (21) has rolling faces (24), on which a loading means (6) of the loading car (1) is movable beneath the support face (2a) of a jacked-up load carrier (2b).

25. The loading system (20) of one of claims 22-24, characterized in that the loading stand (21) has running faces (25) for a resupply system (26).

26. The loading system (20) of one of claims 20-25, characterized in that the readiness zone (3) has at least one buffer (27a, 27b, . . . ) for temporary storage of a load (2) to be loaded.

27. The loading system (20) of one of claims 20-26, characterized in that the readiness zone (3) extends in the travel direction (5a).

28. The loading system (20) of one of claims 26-27, characterized in that a plurality of buffers (27a, 27b, . . . ) are disposed side by side and/or in line with one another in terms of the travel direction (5a).

29. The loading system (20) of one of claims 26-28, characterized in that a resupply system (26) supplies the buffers (27a, 27b, . . . ) with a load (2) and/or load carriers (2b).
